(19) United States
(12) Patent Application Publication
(10) Pub. No.: US 2020/0273095 A1
(43) Pub. Date: Aug. 27, 2020

(54) GENERATING BID VALUES

(71) Applicant: Oath Inc., New York, NY (US)

(72) Inventors: Yair Koren, Zichron Yaacov (IL); Michal Aharon, Haifa (IL); Abraham Shahar, Tel Aviv (IL); Assaf Keret, Rosh Haain (IL); Tal Cohen, Netanya (IL); Yohay Kaplan, Tel-Aviv (IL)

(21) Appl. No.: 16/286,812

(22) Filed: Feb. 27, 2019

(51) Int. Cl. G06Q 30/08

(52) U.S. Cl. CPC G06Q 30/08

(57) ABSTRACT

One or more computing devices, systems, and/or methods for generating bid values are provided. A content item and/or a budget associated with the content item may be identified. A target spend data structure associated with the content item may comprise a plurality of target spend values associated with a plurality of sub-periods of time within a first instance of a period of time. A first update target spend value, associated with a second instance of a first sub-period of time, may be generated based upon a first budget factor calculation associated with the first instance of the first sub-period of time and a second budget factor calculation associated with the first instance of the period of time. A first bid value for presenting the first content item at the second instance of the first sub-period of time may be generated based upon the first update target spend value.

### BACKGROUND

Many applications, such as websites, applications, etc. may provide platforms for viewing media. For example, a user may interact with a service. While interacting with the service, selected media may be presented to the user automatically.

### SUMMARY

In accordance with the present disclosure, one or more computing devices and/or methods are provided. In an example, a first content item and/or a budget associated with the first content item may be received from a client device associated with an entity. A target spend data structure associated with the first content item may be generated. The target spend data structure may comprise a plurality of target spend values. Each target spend value of the plurality of target spend values may be associated with spending performed during a sub-period of time of a plurality of sub-periods of time within a first instance of a period of time. The spending may be performed based upon the budget. The spending may be performed for presenting the first content item via client devices. A first bid value for presenting the first content item at a first instance of a first sub-period of time of the plurality of sub-periods of time may be generated based upon a first target spend value of the plurality of target spend values and/or based upon first historical spending. The first target spend value may be associated with the first instance of the first sub-period of time. A second bid value for presenting the first content item at a first instance of a second sub-period of time of the plurality of sub-periods of time may be generated based upon a second target spend value of the plurality of target spend values and/or based upon second historical spending. The second target spend value may be associated with the first instance of the second sub-period of time. A first update target spend value may be generated based upon a first budget factor calculation corresponding to the first instance of the first sub-period of time and a second budget factor calculation corresponding to the first instance of the period of time. The first update target spend value may be associated with a second instance of the first sub-period of time. A second update target spend value may be generated based upon a third budget factor calculation corresponding to the first instance of the second sub-period of time and the second budget factor calculation. The second update target spend value may be associated with a second instance of the second sub-period of time. A third bid value for presenting the first content item at the second instance of the first sub-period of time may be generated based upon the first update target spend value in the updated target spend data structure and/or based upon third historical spending. A fourth bid value for presenting the first content item at the second instance of the second sub-period of time may be generated based upon the second update target spend value in the updated target spend data structure and/or based upon fourth historical spending.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4A is a first portion of a flow chart illustrating an example method for generating bid values.

FIG. 4B is a second portion of a flow chart illustrating an example method for generating bid values.

FIG. 5A is a target spend chart illustrating an example of a target spend value curve associated with a plurality of target spend values of a target spend data structure.

FIG. 5B is a target cumulative spend chart illustrating an example of a target cumulative spend curve.

FIG. 5C is a budget factor chart comprising an example of a budget factor value curve associated with a first plurality of budget factor values and a budget factor value constant associated with the first plurality of budget factor values.

FIG. 5D is a component block diagram illustrating an example system for generating a plurality of exemplary update target spend values based upon a plurality of exemplary budget factor calculations.

FIG. 5E is a second target cumulative spend chart illustrating an example of a second target cumulative spend curve.

FIG. 5F is a component block diagram illustrating an example system for generating bid values, where a banner is presented via an exemplary client device.

FIG. 5G is a third target cumulative spend chart illustrating an exemplary target cumulative spend curve.

FIG. 6 is an illustration of a scenario featuring an example non-transitory machine readable medium in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

1. Computing Scenario

The following provides a discussion of some types of computing scenarios in which the disclosed subject matter may be utilized and/or implemented.

1.1. Networking

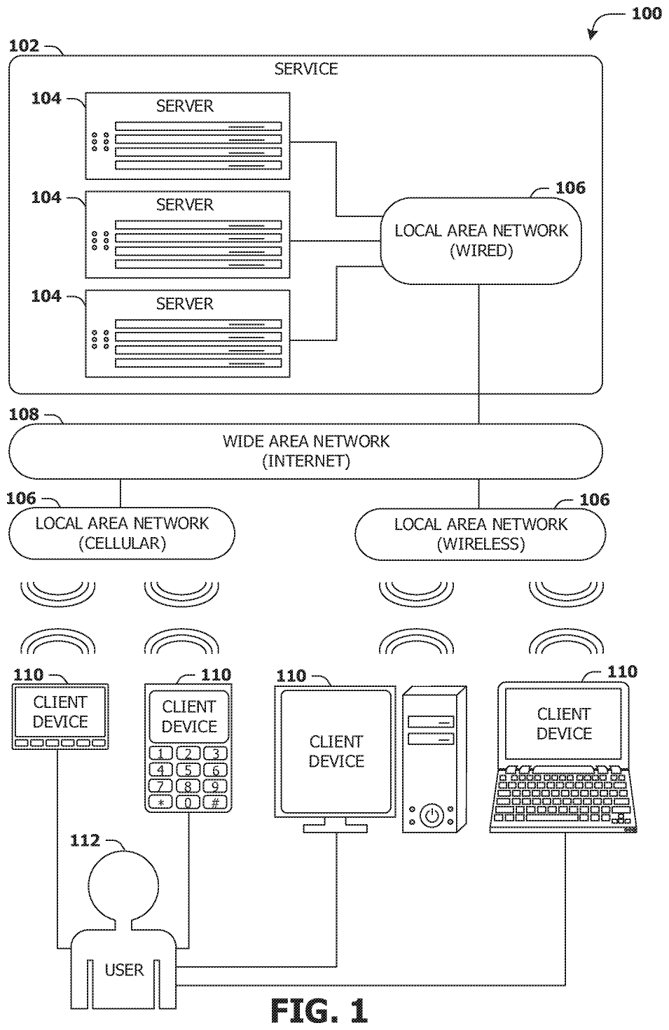

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fiber Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 (and/or via a wired network) provided by a location such as the user's home or workplace (e.g., a WiFi (Institute of Electrical and Electronics Engineers (IEEE) Standard 802.11) network or a Bluetooth (IEEE Standard 802.15.1) personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

1.2. Server Configuration

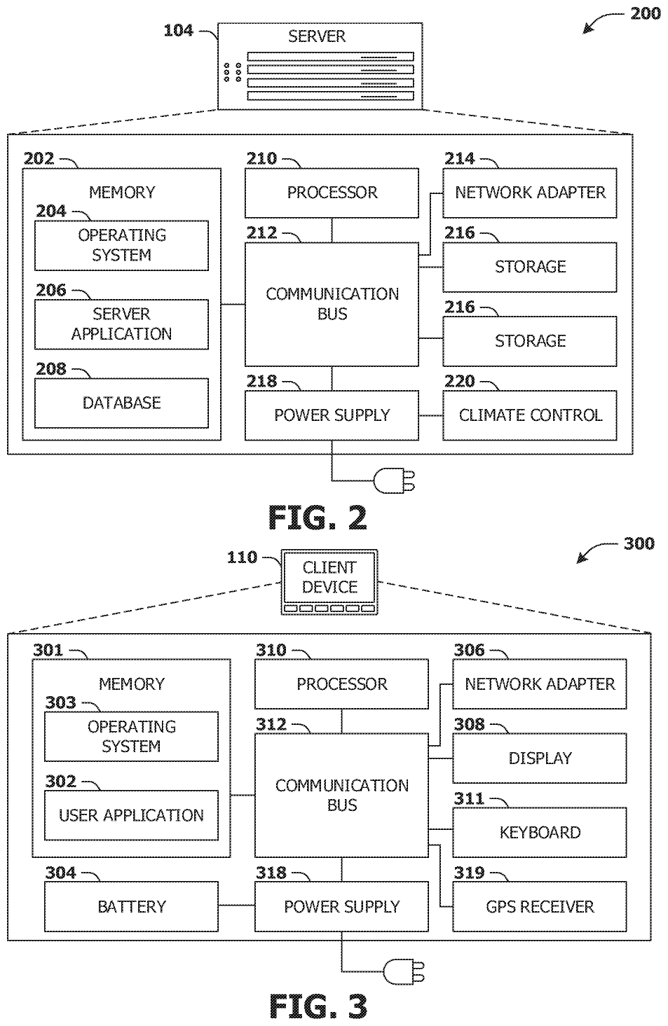

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110. Other components that may optionally be included with the client device 110 (though not shown in the schematic architecture diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

2. Presented Techniques

One or more computing devices and/or techniques for generating bid values are provided. For example, an entity may access and/or interact with a service, such as an advertising service, that provides a platform for uploading content to one or more servers to be presented via client devices. For example, the content may comprise one or more content items (e.g., images, videos, audio, interactive graphical objects, etc.). In some examples, the one or more content items may correspond to one or more advertisements associated with the entity (e.g., the one or more advertisements may be associated with one or more products, one or more services, etc. provided by the entity). Alternatively and/or additionally, the platform may be used to upload information associated with the content. For example, the information may comprise a budget associated with a content item (e.g., an advertisement) of the one or more content items. For example, the budget may correspond to a daily budget for the content item.

In some examples, a plurality of bid values associated with the content item may be generated throughout a period of a day based upon the budget and/or may be submitted into an auction module. In some examples, the plurality of bid values may be generated based upon a target spend pattern and/or based upon historical spending (e.g., actual spending performed during one or more historical sub-periods of time). For example, the target spend pattern may be a uniform target spend pattern associated with uniform budget pacing, such that spending performed throughout the day is performed uniformly and/or linearly. However, presenting the content item during some times of the day may require higher bids (and/or higher costs) than other times of the day. Thus, it may be beneficial not to spend uniformly throughout the day such that less of the budget is spent during times of day associated with higher bids (and/or higher costs) and more of the budget is spent during times of day associated with lower bids (and/or lower costs). Accordingly, by spending less of the budget during the times of day associated with higher bids (and/or higher costs) and/or by spending more of the budget during the times of day associated with lower bids (and/or lower costs), the content item may be presented on more occasions than if spending occurs uniformly throughout the day.

In some examples, rather than attempting to spend uniformly throughout the day, an attempt may be made to exert a uniform amount of effort throughout the day. For example, by attempting to exert the uniform amount of effort throughout the day, the plurality of bid values may be generated having similar values (throughout the day). A standard deviation, a variance and/or a difference amongst the plurality of bid values may be less when attempting to exert the uniform amount of effort throughout the day as compared to attempting to spend uniformly throughout the day.

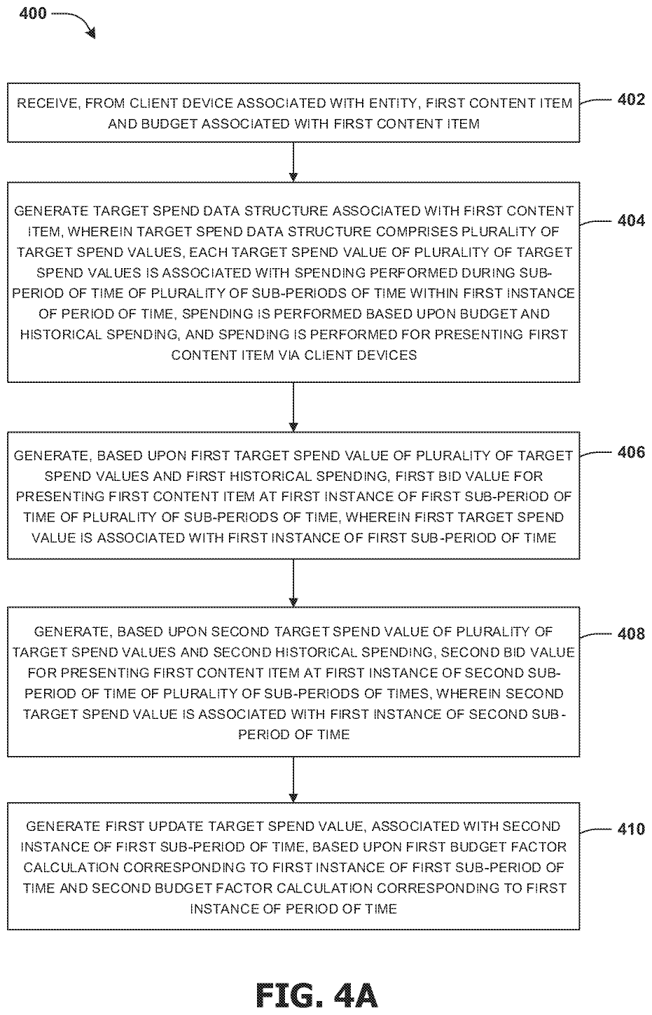

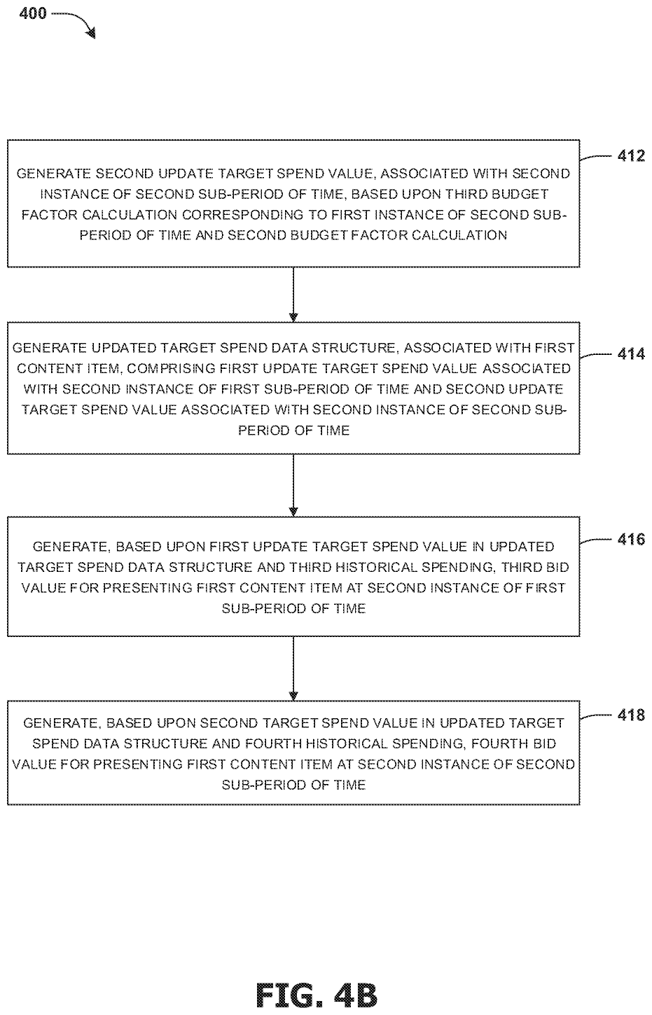

An embodiment of generating bid values is illustrated by an example method 400 of FIGS. 4A-4B. In some examples, an entity may access and/or interact with a service, such as an advertising service, that provides a platform for uploading content to be presented via client devices to a content system. In some examples, the content system may be an advertisement system. Alternatively and/or additionally, the content system may provide content items to be presented via pages associated with the content system. For example, the pages may be associated with websites (e.g., websites providing search engines, email services, news content, communication services, etc.) associated with the content system. The content system may provide content items to be presented in (dedicated) locations throughout the pages (e.g., one or more areas of the pages configured for presentation of content items). For example, a content item may be presented at the top of a web page associated with the content system (e.g., within a banner area), at the side of the web page (e.g., within a column), in a pop-up window, overlaying content of the web page, etc. Alternatively and/or additionally, a content item may be presented within an application (e.g., a mobile application) associated with the content system and/or within a game associated with the content system. Alternatively and/or additionally, a user may be required to watch and/or interact with the content item before the user can access content of a web page, utilize resources of an application and/or play a game.

In some examples, serving areas may correspond to websites, web pages, applications, games, etc. where content items associated with the content system are presented. For example, one or more serving areas associated with the content system may correspond to first party serving areas (e.g., owned and operated serving areas). For example, the first party serving areas may correspond to websites, applications, games, etc., that are owned and/or provided by a content entity associated with the content system, where content items associated with the content system are presented. Alternatively and/or additionally, one or more serving areas associated with the content system may correspond to third party serving areas. For example, the third party serving areas may correspond to websites, applications, games, etc., that are owned and/or provided by one or more entities different than the content entity associated with the content system, where content items associated with the content system are presented.

At 402, a first content item and/or a budget associated with the first content item may be received from a first client device associated with a first entity. In some examples, the first entity may be an advertiser, a company, a brand, an organization, etc. Alternatively and/or additionally, the first content item may comprise one or more of an image, a video, audio, an interactive graphical object, etc. In some examples, the first content item may be an advertisement associated with the first entity (e.g., the advertisement may be associated with one or more products, one or more services, etc. provided by the first entity).

Alternatively and/or additionally, content information associated with the first content item and/or the first entity may be received. For example, the information may comprise one or more of the budget, an amount of spending performed thus far, a number of impressions associated with the first content item thus far, a number of interactions associated with the first content item thus far, a duration of time for which the first content item will be presented by the content system, one or more advertisement campaign goals associated with the first content item (e.g., whether the entity is interested in clicks, conversions, and/or other interactions with respect to the content item), a first content item bid value associated with the first content item, etc. In some examples, the budget may correspond to a budget to be spent during a period of time. For example, the content system may attempt to spend the (entire) budget for presenting the first content item via client devices during the period of time. In some examples, the period of time may correspond to a day and/or a period of 24 hours and/or the budget may correspond to a daily budget. For example, the content system may attempt to spend the (entire) budget for presenting the first content item via client devices during the day and/or during the period of 24 hours.

At 404, a target spend data structure associated with the first content item may be generated. In some examples, the target spend data structure may correspond to a target spend pattern. Bid values may be generated and/or the budget may be spent during a first instance of the period of time based upon the target spend pattern. In some examples, the target spend data structure may comprise a plurality of target spend values. Each target spend value of the plurality of target spend values may be associated with spending performed during a sub-period of time of a plurality of sub-periods of time within the first instance of the period of time. For example, spending (of the budget) may be performed during a first instance of a first sub-period of time within the first instance of the period of time based upon a first target spend value of the plurality of target spend values and/or based upon the budget and/or based upon historical spending (e.g., actual spending performed during one or more historical sub-periods of time and/or during a current sub-period of time).

In some examples, each target spend value of the plurality of target spend values may correspond to a rate at which spending of the budget is attempted during a corresponding sub-period of time of the plurality of sub-periods of time (e.g., the rate may be associated with a slope associated with the target spend pattern). Alternatively and/or additionally, each target spend value of the plurality of target spend values may correspond to an amount of budget attempted to be spent during a corresponding sub-period of time of the plurality of sub-periods of time.

In some examples, each sub-period of time of the plurality of sub-periods of time may correspond to a portion of the period of time. For example, each sub-period of time of the plurality of sub-periods of time may correspond to one of a day, an hour, 30 minutes, 3 minutes, 1 minute, etc. of the period of time.

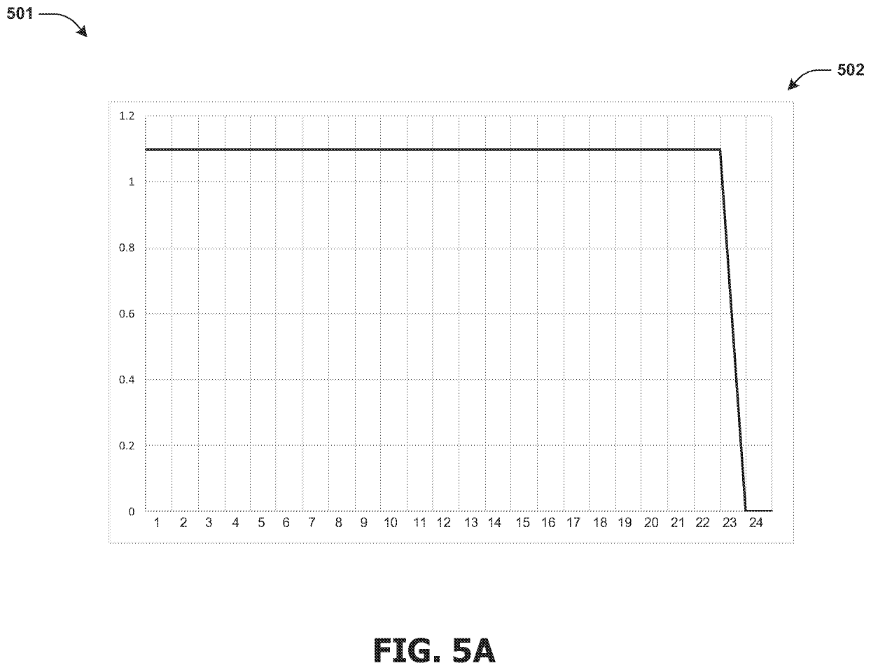

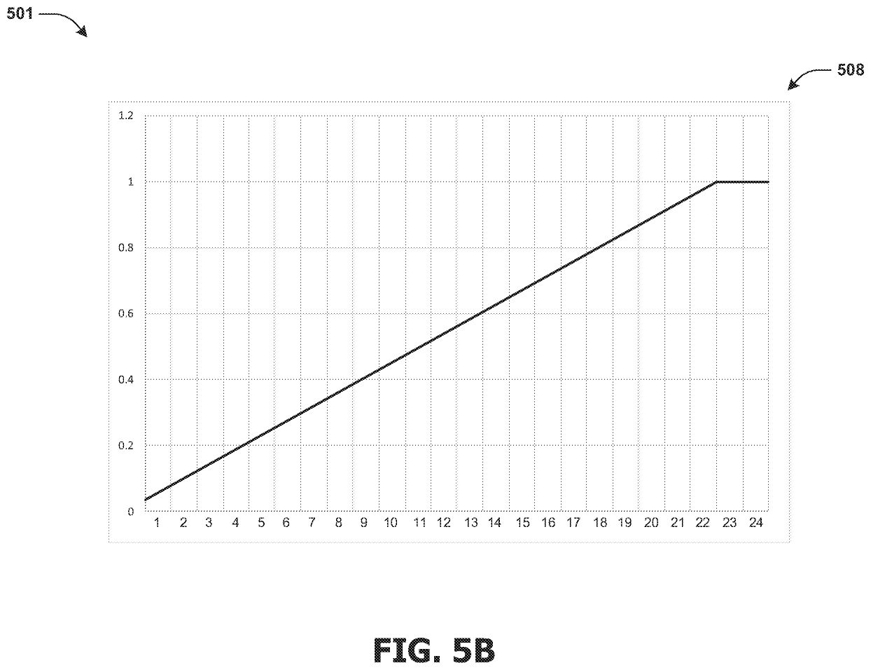

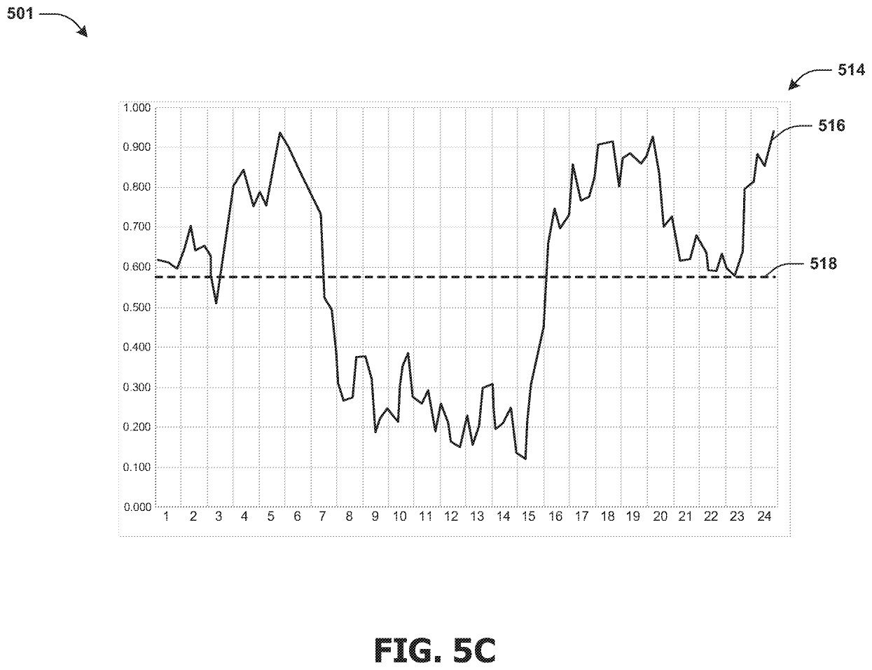

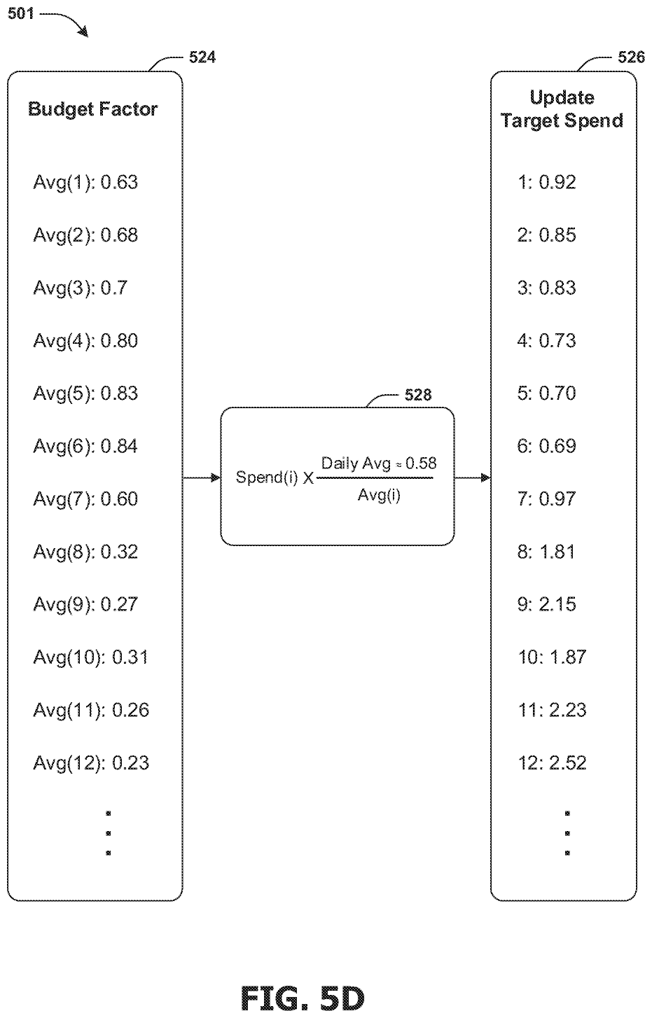

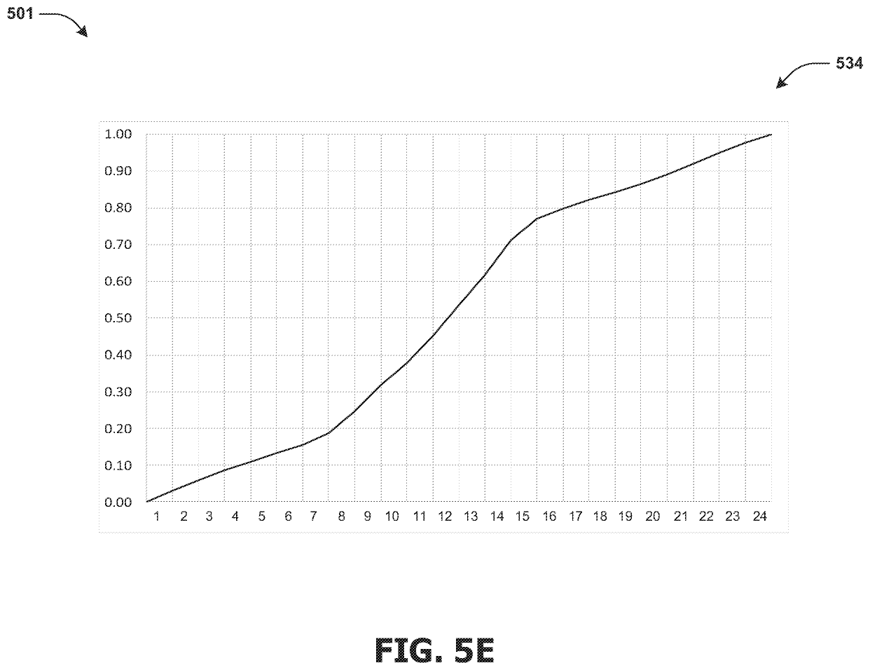

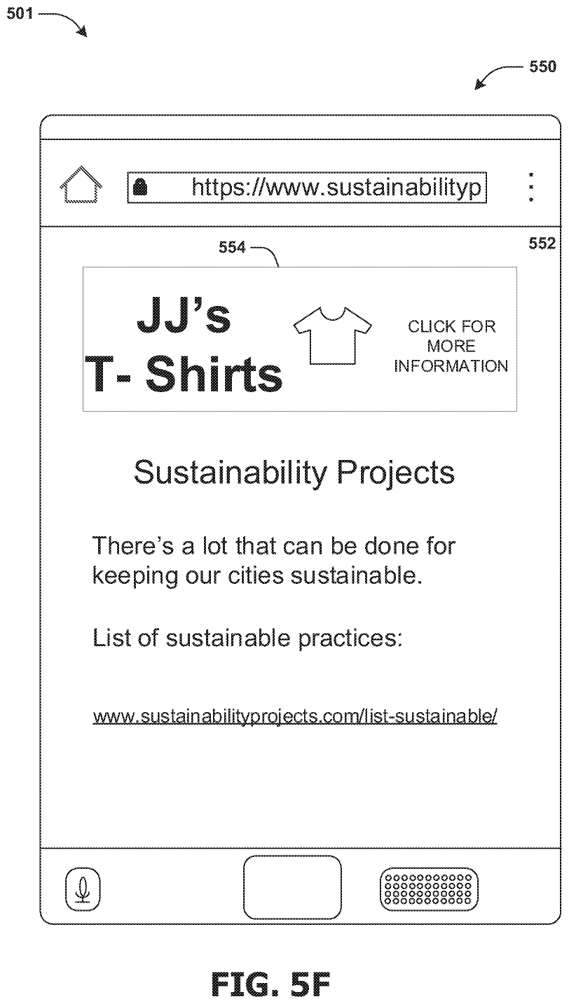

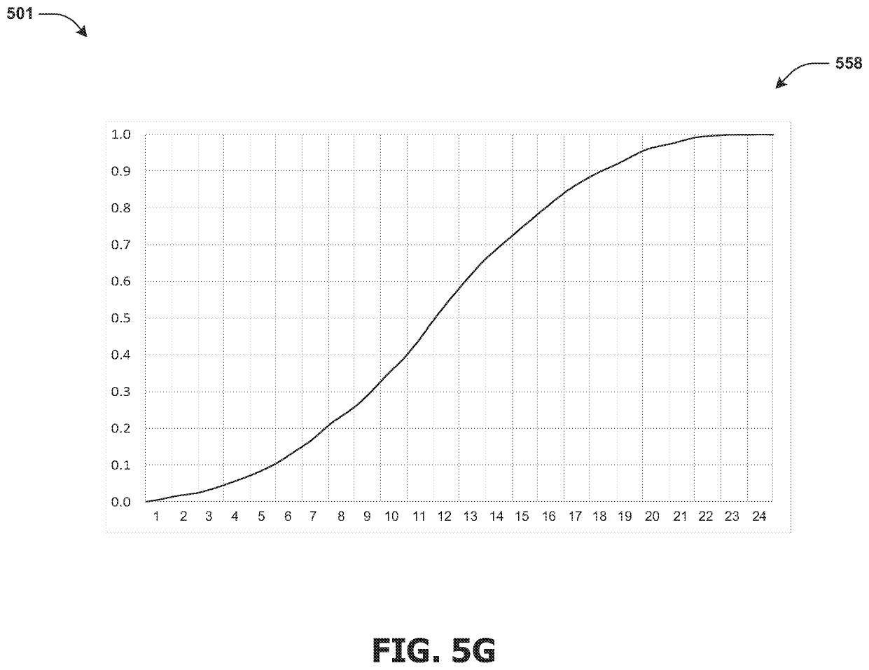

FIGS. 5A-5G illustrate an example system 501 for generating bid values. FIG. 5A illustrates a target spend chart 502 illustrating an example of a target spend value curve associated with the plurality of target spend values of the target spend data structure. The vertical axis of FIG. 5A may be indicative of a rate of spending and/or the horizontal axis of FIG. 5A may be indicative of sub-periods of time. In some examples, the period of time may correspond to a period of 24 hours and/or each sub-period of time of the plurality of sub-periods of time may correspond to an hour of the period of 24 hours. For example, the first sub-period of time (e.g., sub-period of time 1) may correspond to a first hour of the period of 24 hours, the second sub-period of time (e.g., sub-period of time 2) may correspond to a second hour of the period of 24 hours, etc.

FIG. 5B illustrates a target cumulative spend chart 508 illustrating an example of a target cumulative spend curve. The vertical axis of FIG. 5B may be indicative of a proportion of the budget that is to be spent and/or the horizontal axis of FIG. 5B may be indicative of sub-periods of time. For example, the target cumulative spend curve may be associated with target spending of the budget throughout the first instance of the period of time. Alternatively and/or additionally, an attempt may be made to perform spending of the budget throughout the first instance of the period of time in association with the target cumulative spend curve. The target cumulative spend curve of the target cumulative spend chart 508 may be associated with the target spend value curve of the target spend chart 502 (e.g., both the target cumulative spend curve and the target spend value curve may be associated with an attempt to perform spending of the budget throughout the first instance of the period of time uniformly and/or linearly).

In some examples, each target spend value of the plurality of target spend values may be set to a first value (e.g., each target spend value of the plurality of target spend values may be set to 1). Alternatively and/or additionally, as illustrated in the exemplary target spend chart 502 in FIG. 5A, a first portion of the plurality of target spend values may be set to a second value (e.g., approximately 1.1) and/or a second portion of the plurality of target spend values may be set to a third value (e.g., less than 1.1 and/or 0). For example, as illustrated in the exemplary target spend chart 502 in FIG. 5A, the first portion of the plurality of target spend values may correspond to 22 (initial) hours of the period of 24 hours. Alternatively and/or additionally, the second portion of the plurality of target spend values may correspond to 2 (last) hours of the period of 24 hours. For example, the 22 (initial) hours of the period of 24 hours may be associated with active hours of the period of 24 hours. For example, an attempt may be made to spend the (entire) budget during the active hours of the period of 24 hours.

In some examples, the plurality of target spend values may be associated with a uniform target spend pattern associated with uniform budget pacing, such that spending performed throughout the first instance of the period of time is attempted to be performed uniformly and/or linearly. For example, the plurality of sub-periods of time within the first instance of the period of time may be associated with target spend values that are equal to and/or approximately equal to each other. Alternatively and/or additionally, active sub-periods of time within the first instance of the period of time may be associated with target spend values that are equal to each other (as shown by the target cumulative spend chart 508 in FIG. 5B where spending of the budget is attempted to be performed uniformly and/or linearly throughout the active hours of the period of 24 hours). For example, each active sub-period of time of the active sub-periods of time may be associated with a similar rate at which spending of the budget is attempted during the active sub-period of time. Alternatively and/or additionally, each active sub-period of time of the active sub-periods of time may be associated with a similar amount of budget attempted to be spent during the active sub-period of time.

Alternatively and/or additionally, if the first content item and/or the budget associated with the first content item are received from the first client device during the first instance of the period of time (e.g., after one or more sub-periods of time of the first instance of the period of time have already passed), then the target spend data structure and/or the plurality of target spend values may be generated such that the (entire) budget is attempted to be spent during remaining active sub-periods of time of the first instance of the period of time. For example, a set of target spend values associated with sub-periods of time that occurred prior to receiving the first content item may be set to 0. Alternatively and/or additionally, a second set of target spend values, associated with remaining active sub-periods of time after the first content item and/or the budget is received, may be set to a fourth value associated with attempting to spend the (entire) budget uniformly and/or linearly during the active sub-periods of time after the first content item and/or the budget are received. For example, an attempt may be made to spend the (entire) budget uniformly and/or linearly during the active sub-periods of time after the first content item and/or the budget is received, based upon the second set of target spend values.

In some examples, during the first instance of the period of time (e.g., a first instance of the period of 24 hours), a first plurality of bid values may be generated. Alternatively and/or additionally, the first plurality of bid values may be generated based upon the target spend data structure and/or the plurality of target spend values. Alternatively and/or additionally, the first plurality of bid values may be generated based upon historical spending (e.g., actual spending performed during one or more historical sub-periods of time and/or during a current sub-period of time). For example, for each sub-period of time of the plurality of sub-periods of time (and/or for each active sub-period of time of the active sub-periods of time), a set of bid values may be generated based upon a corresponding target spend value (e.g., a target spend value corresponding to the sub-period of time) and/or based upon historical spending (e.g., actual spending performed during one or more historical sub-periods of time and/or during a current sub-period of time).

For example, a first set of bid values (of the first plurality of bid values) may be generated at the first instance of the first sub-period of time (e.g., at a first instance of the first hour within the first instance of the period of 24 hours) based upon the first target spend value and/or based upon historical spending (e.g., actual spending performed during one or more historical sub-periods of time and/or during the first instance of the first sub-period of time). For example, at 406, a first bid value for presenting the first content item at the first instance of the first sub-period of time may be generated. For example, the first bid value may be generated based upon the first target spend value (of the plurality of target spend values) associated with the first instance of the first sub-period of time and/or based upon first historical spending (e.g., actual spending performed during one or more historical sub-periods of time and/or during the first instance of the first sub-period of time). In some examples, the first historical spending may correspond to spending of the budget that occurred during one or more sub-periods of time prior to the first instance of the first sub-period of time and/or spending of the budget that occurred during the first instance of the first sub-period of time prior to generating the first bid value.

Alternatively and/or additionally, the first bid value may be generated based upon the first content item bid value (e.g., the first content item bid value may be received from the first client device associated with the first entity and/or the first content item bid value may be generated based upon the budget) and/or a first budget factor value. For example, the first budget factor value may be generated based upon the first target spend value associated with the first instance of the first sub-period of time and/or based upon historical spending, (e.g., the first historical spending). Alternatively and/or additionally, one or more operations (e.g., mathematical operations) may be performed to combine the first budget factor value with the first content item bid value to generate the first bid value. In some examples, the first budget factor value may be a multiplicative factor. For example, the first content item bid value may be multiplied by the first budget factor value to generate the first bid value.

In some examples, a first set of budget factor values may be generated based upon the first target spend value associated with the first instance of the first sub-period of time and/or based upon historical spending (e.g., actual spending performed during one or more historical sub-periods of time and/or during the first instance of the first sub-period of time). In some examples, each budget factor value of the first set of budget factor values may be used for generating one or more bid values for a unit of time (e.g., one or more of 30 seconds, 1 minute, etc.). For example, upon completion of an instance of the unit of time, an exemplary budget factor value of the first set of budget factor values may be modified to a second exemplary budget factor value of the first set of budget factor values based upon spending during the instance of unit of time. For example, the exemplary budget factor value may be modified and/or updated such that spending is performed (and/or bid values are generated) in association with the target spend pattern and/or the first target spend value.

In some examples, the first set of bid values may be submitted into an auction module associated with the content system. For example, the first bid value of the first set of bid values may be submitted into the auction module and/or included in a plurality of participating bid values associated with a plurality of participating content items participating in an auction for presenting a selected content item via a client device. The auction module may analyze the plurality of participating bid values and/or the plurality of participating content items. The auction module may select a winner content item, for presentation via a client device, from the plurality of participating content items based upon the plurality of participating bid values and/or the plurality of participating content items. For example, the winner content item may be selected responsive to a determination that the winner content item is associated with a highest bid value of the plurality of participating bid values. Alternatively and/or additionally, the winner content item may be selected responsive to a determination that the winner content item is associated with a highest predicted probability of a user associated with the client device positively engaging with the content item. Alternatively and/or additionally, the winner content item may be selected based upon a combination (e.g., a product) of a bid value associated with the winner content item and a predicted probability of the user positively engaging with the content item. Alternatively and/or additionally, the winner content item may be selected based upon one or more of (identities of) entities associated with the plurality of participating content items, contexts (e.g., topics, subject matters, types, etc.) associated with the plurality of participating content items, etc. In some examples, the winner content item may be presented via a serving area on a client device. In some examples, responsive to receiving a request for content from the client device, the plurality of participating bid values and/or the plurality of participating content items may be analyzed, the winner content item may be selected and/or the winner content item may be presented via the serving area on the client device.

Alternatively and/or additionally, a second set of bid values (of the first plurality of bid values) may be generated at the first instance of the second sub-period of time (e.g., at a first instance of the second hour within the first instance of the period of 24 hours) based upon the second target spend value and/or based upon historical spending (e.g., actual spending performed during one or more historical sub-periods of time and/or during the first instance of the second sub-period of time. At 408, a second bid value for presenting the first content item at the first instance of the second sub-period of time may be generated. For example, the second bid value may be generated based upon the second target spend value (of the plurality of target spend values) associated with the first instance of the second sub-period of time and/or based upon second historical spending (e.g., actual spending performed during one or more historical sub-periods of time and/or during the first instance of the second sub-period of time. In some examples, the second historical spending may correspond to spending of the budget that occurred during one or more sub-periods of time prior to the first instance of the second sub-period of time and/or spending of the budget that occurred during the first instance of the second sub-period of time prior to generating the second bid value.

Alternatively and/or additionally, the second bid value may be generated based upon the first content item bid value and/or a second budget factor value. For example, the second budget factor value may be generated based upon the second target spend value and/or based upon historical spending (e.g., the second historical spending). Alternatively and/or additionally, one or more operations (e.g., mathematical operations) may be performed to combine the second budget factor value with the first content item bid value to generate the second bid value. In some examples, the second budget factor value may be a multiplicative factor. For example, the first content item bid value may be multiplied by the second budget factor value to generate the second bid value.

In some examples, a second set of budget factor values may be generated based upon the second target spend value associated with the first instance of the second sub-period of time and/or based upon historical spending (e.g., actual spending performed during one or more historical sub-periods of time and/or during the first instance of the second sub-period of time). Alternatively and/or additionally, each bid value of the second set of bid values may be generated based upon the first content item bid value and/or a budget factor value of the second set of budget factor values. In some examples, the second set of bid values may be submitted into the auction module associated with the content system.

In some examples, a first plurality of budget factor values may be generated throughout the first instance of the period of time. For example, the first plurality of budget factor values may comprise the first set of budget factor values (corresponding to the first instance of the first sub-period of time) and/or the second set of budget factor values (corresponding to the first instance of the second sub-period of time).

In some examples, the first plurality of budget factor values may be generated based upon the plurality of target spend values in the target spend data structure. For example, each budget factor value of the first plurality of budget factor values may be generated in association with generating a bid value for presenting the first content item via a client device. Alternatively and/or additionally, each budget factor value of the first plurality of budget factor values may be controlled such that spending (of the budget) is performed in association with the plurality of target spend values and/or in association with the target spend pattern. For example, the first plurality of budget factor values may be controlled such that spending (of the budget) is performed uniformly and/or linearly throughout the first instance of the period of time (and/or throughout the active sub-periods of time within the first instance of the period of time).

FIG. 5C illustrates a budget factor chart 514 comprising an example of a budget factor value curve 516 associated with the first plurality of budget factor values and/or a budget factor value constant 518 associated with the first plurality of budget factor values. The vertical axis of FIG. 5C may be indicative of a budget factor value and/or the horizontal axis of FIG. 5C may be indicative of sub-periods of time. In some examples, the budget factor value constant 518 may correspond to an average (e.g., a mean, a median and/or a mode) and/or a different combination of the first plurality of budget factor values (e.g., budget factor values of the first plurality of budget factor values are generated throughout the first instance of the period of time). Alternatively and/or additionally, the budget factor value constant 518 may correspond to a median (and/or a different statistical characteristic) of the first plurality of budget factor values.

As shown in the budget factor chart 514, budget factor values associated with various sub-periods of time of the first instance of the period of time are higher than budget factor values associated with other sub-periods of time of the first instance of the period of time. For example, sub-periods of time 1-7 (e.g., the first hour through a seventh hour of the period of 24 hours) and/or sub-periods of time 16-24 (e.g., a sixteenth hour through a twenty-fourth hour of the period of 24 hours) may be associated with budget factor values that are higher than the budget factor value constant 518 (and/or the average of the first plurality of budget factor values). Alternatively and/or additionally, sub-periods of time 8-15 (e.g., an eighth hour through a fifteenth hour of the period of 24 hours) may be associated with budget factor values that are less than the budget factor value constant 518 (and/or the average of the first plurality of budget factor values).

The sub-periods of time 1-7 and/or the sub-periods of time 16-24 being associated with budget factor values that are higher than the budget factor value constant 518 and/or the sub-periods of time 8-15 being associated with budget factor values that are lower than the budget factor value constant 518 may correspond to the sub-periods of time 1-7 and/or the sub-periods of time 16-24 being associated with bid values that are higher than bid values associated with the sub-periods of time 8-15. Accordingly, for each instance that the first content item is presented via a client device during the sub-periods of time 1-7 and/or the sub-periods of time 16-24, more of the budget may be spent as compared with during the sub-periods of time 8-15.

Alternatively and/or additionally, for each instance that a user and/or a client device interacts with the first content item (and/or clicks on the first content item) via a serving area of the serving areas during the sub-periods of time 1-7 and/or the sub-periods of time 16-24, more of the budget may be spent as compared with during the sub-periods of time 8-15.

Alternatively and/or additionally, for each conversion (e.g., an action, such as one or more of a purchase associated with the first content item, contacting the first entity, etc.) that occurs via a presentation of the first content item via a serving area during the sub-periods of time 1-7 and/or the sub-periods of time 16-24, more of the budget may be spent as compared with during the sub-periods of time 8-15.

Thus, as a result of attempting to spend (the budget) uniformly throughout the first instance of the period of time (and/or the period of 24 hours), a higher amount of effort (e.g., associated with higher bid values, higher costs, etc.) may be exerted to present the first content item via client devices, receive clicks (and/or interactions) associated with the first content item and/or achieve conversions during the sub-periods of time 1-7 and/or during the sub-periods of time 16-24 as compared with during the sub-periods of time 8-15.

In some examples, the sub-periods of time 1-7 and/or the sub-periods of time 16-24 may be associated with budget factor values that are higher than the budget factor value constant 518 because of a lower amount of internet traffic and/or a lower amount of user activity with the serving areas as compared with the sub-periods of time 8-15 (and/or other reasons). For example, the lower amount of internet traffic and/or the lower amount of user activity may result in a lower supply of client devices requesting content from the content system. Thus, higher costs (and/or higher bid values) (e.g., more effort) may be required to present (and/or achieve user interaction with) the first content item via a client device during the sub-periods of time 1-7 and/or the sub-periods of time 16-24 as compared with during the sub-periods of time 8-15.

Accordingly, it may be beneficial to attempt to exert a uniform amount of effort throughout the period of 24 hours and/or to spend in a non-uniform and/or non-linear manner. For example, by attempting to spend less (of the budget) during the sub-periods of time 1-7 and/or the sub-periods of time 16-24 and/or by attempting to spend more (of the budget) during the sub-periods of time 8-15 the first content item may be presented in more instances, more clicks and/or interactions associated with the first content item may be received and/or more conversions may be achieved as compared with spending uniformly and/or linearly throughout the period of 24 hours.

In some examples, a budget factor value data structure associated with the first instance of the period of time may be generated. For example, the budget factor value data structure may comprise a plurality of budget factor calculations. For example, each budget factor calculation of the plurality of calculated budget factor calculations may be associated with a sub-period of time of the plurality of sub-periods of time within the first instance of the period of time. Alternatively and/or additionally, each budget factor calculation of the plurality of budget factor calculations may be associated with a set of budget factor values associated with a sub-period of time within the first instance of the period of time.

In some examples, each budget factor calculation of the plurality of budget factor calculations may be associated with (and/or may be equal to) a combination of a set of budget factor values associated with a sub-period of time within the first instance of the period of time. Alternatively and/or additionally, each budget factor calculation of the plurality of budget factor calculations may be associated with (and/or may be equal to) an average (e.g., a mean, a median and/or a mode) of a set of budget factor values associated with a sub-period of time within the first instance of the period of time.

For example, a first budget factor calculation of the plurality of budget factor calculations may be associated with the first set of budget factor values associated with the first instance of the first sub-period of time. In some examples, the first budget factor calculation may be associated with (and/or may be equal to) a combination of the first set of budget factor values. Alternatively and/or additionally, the first budget factor calculation may be associated with (and/or may be equal to) an average (e.g., a mean, a median and/or a mode) of the first set of budget factor values.

Alternatively and/or additionally, a second budget factor calculation of the plurality of budget factor calculations may be associated with the second set of budget factor values associated with the first instance of the second sub-period of time. In some examples, the second budget factor calculation may be associated with (and/or may be equal to) a combination of the second set of budget factor values. Alternatively and/or additionally, the second budget factor calculation may be associated with (and/or may be equal to) an average (e.g., a mean, a median and/or a mode) of the second set of budget factor values.

In some examples, an updating process may be performed for a second instance of the period of time. For example, the updating process may comprise generating an updated target spend data structure corresponding to an updated target spend pattern. For example, during the second instance of the period of time, bid values may be generated and/or spending (of the budget) may be performed based upon the updated target spend data structure and/or the updated target spend pattern and/or based upon historical spending (e.g., actual spending performed during one or more historical sub-periods of time and/or during a current sub-period of time). In some examples, the second instance of the period of time may begin upon completion of the first instance of the period of time. For example, if the period of time is the period of 24 hours, the second instance of the period of time may begin upon completion of the first instance of the period of 24 hours.

In some examples, a plurality of update target spend values may be generated based upon the budget factor value data structure and/or the plurality of budget factor calculations. For example, each update target spend value may be associated with a sub-period of time of the plurality of sub-periods of time within the second instance of the period of time.

At 410, a first update target spend value (of the plurality of update target spend values) may be generated based upon the first budget factor calculation corresponding to the first instance of the first sub-period of time and/or a third budget factor calculation. For example, the third budget factor calculation may be equal to the average of the first plurality of budget factor values corresponding to the first instance of the period of time. Alternatively and/or additionally, the third budget factor value may be equal to a different combination and/or statistic associated with the first plurality of budget factor values corresponding to the first instance of the period of time. In some examples, the first update target spend value may be associated with a second instance of the first sub-period of time.

In some examples, the first update target spend value may comprise a combination of the first budget factor calculation and the third budget factor calculation (e.g., the average of the first plurality of budget factor values). For example, one or more operations (e.g., mathematical operations) may be performed to combine the first budget factor calculation and the third budget factor calculation to generate the first update target spend value. Alternatively and/or additionally, the first update target spend value may be generated by dividing the third budget factor calculation by the first budget factor calculation (and/or by performing a different mathematical operation using the first budget factor calculation and the third budget factor calculation).

In some examples, a first update factor may be generated. If the third budget factor calculation is less than an epsilon value (e.g., 0.0002 and/or a different value) and/or if the first budget factor calculation is less than the epsilon value, the first update factor may be set to 1.0 (and/or a different value). Alternatively and/or additionally, if the third budget factor calculation is greater than the epsilon value and/or if the first budget factor calculation is greater than the epsilon value, the first update factor may be equal to a combination of the first budget factor calculation and the third budget factor calculation (e.g., the first update factor may be generated by dividing the third budget factor calculation by the first budget factor calculation (and/or by performing one or more different mathematical operations using the first budget factor calculation and the third budget factor calculation)).

Alternatively and/or additionally, if the combination of the first budget factor calculation and the third budget factor calculation is greater than a maximum update factor (e.g., 2 and/or a different value), the first update factor may be set to the maximum update factor rather than the combination of the first budget factor calculation and the third budget factor calculation.

In some examples, the first update target spend value may be set to a combination of the first update factor and the first target spend value (of the target spend data structure). In some examples, the combination of the first update factor and the first target spend value may correspond to a product of the first update factor and the first target spend value. For example, the first update target spend value may be set to (a value equal to) the first update factor multiplied by the first target spend value.

In some examples, responsive to determining that the first update target spend value is less than a minimum spend value (e.g., 0.1 and/or a different value), the first update target spend value may be set to the minimum spend value. Alternatively and/or additionally, responsive to determining that the first update target spend value is greater than a maximum spend value (e.g., 24 and/or a different value), the first update target spend value may be set to the maximum spend value.

At 412, a second update target spend value (of the plurality of update target spend values) may be generated based upon the second budget factor calculation corresponding to the first instance of the second sub-period of time and/or the third budget factor calculation corresponding to the first instance of the period of time. In some examples, the second update target spend value may be associated with a second instance of the second sub-period of time.

In some examples, the second update target spend value may comprise a combination of the second budget factor calculation and the third budget factor calculation. Alternatively and/or additionally, the second update target spend value may be generated by dividing the third budget factor calculation by the second budget factor calculation (and/or by performing a different mathematical operation using the second budget factor calculation and the third budget factor calculation).

In some examples, a second update factor may be generated. Alternatively and/or additionally, if the third budget factor calculation is less than the epsilon value and/or if the second budget factor calculation is less than the epsilon value, the second update factor may be set to 1.0 (and/or a different value). Alternatively and/or additionally, if the third budget factor calculation is greater than the epsilon value and/or if the second budget factor calculation is greater than the epsilon value, the second update factor may be equal to a combination of the second budget factor calculation and the third budget factor calculation (e.g., the second update factor may be generated by dividing the third budget factor calculation by the second budget factor calculation (and/or by performing one or more different mathematical operations using the second budget factor calculation and the third budget factor calculation)).

Alternatively and/or additionally, if the combination of the second budget factor calculation and the third budget factor calculation is greater than the maximum update factor, the second update factor may be set to the maximum update factor.

In some examples, the second update target spend value may be set to a combination of the second update factor and the second target spend value (of the target spend data structure). In some examples, the combination of the second update factor and the second target spend value may correspond to a product of the second update factor and the second target spend value. For example, the second update target spend value may be set to (a value equal to) the second update factor multiplied by the second target spend value.

In some examples, responsive to determining that the second update target spend value is less than the minimum spend value, the second update target spend value may be set to the minimum spend value. Alternatively and/or additionally, responsive to determining that the second update target spend value is greater than the maximum spend value, the second update target spend value may be set to the maximum spend value.

FIG. 5D illustrates a plurality of exemplary update target spend values 526 being generated based upon a plurality of exemplary budget factor calculations 524 and/or the target spend data structure. For example, the plurality of exemplary budget factor calculations 524 may be comprised within the budget factor value data structure. In some examples, one or more operations 528 may be performed using each budget factor calculation of the plurality of exemplary budget factor calculations 524 to generate the plurality of exemplary update target spend values 526. For example, the one or more operations 528 may comprise dividing the third budget factor calculation by a budget factor calculation of the plurality of exemplary budget factor calculations 524 associated with a first instance of a sub-period of time to generate an update factor. The update factor may be multiplied by a target spend value (of the target spend data structure) associated with the first instance of the sub-period of time to generate an update target spend value, of the plurality of exemplary update target spend values 526, associated with a second instance of the sub-period of time within the second instance of the period of time.

At 414, the updated target spend data structure may be generated. For example, the updated spend data structure may comprise the plurality of update target spend values (comprising the first update target spend value associated with the second instance of the first sub-period of time and the second update target spend value associated with the second instance of the second sub-period of time).

Alternatively and/or additionally, the plurality of update target spend values may undergo one or more smoothing processes associated with a smoothing factor (e.g., 0.5 and/or a different value). For example, an exemplary update target spend value of the plurality of update target spend values may be modified to a smoothed update target spend value. For example, the smoothed update target spend value may be equal to:

$$( \frac{smoothingFactor}{2} \times ( firstNeighborValue + secondNeighborValue ) ) + ( ( 1 - smoothingFactor ) \times exemplary update target spend value ) .$$

In some examples, firstNeighborValue may correspond to an update target spend value of the plurality of update target spend values that is associated with a sub-period of time that (directly) precedes and/or neighbors an exemplary sub-period of time associated with the exemplary update target spend value (that is being modified to the smoothed update target spend value). Alternatively and/or additionally, secondNeighborValue may correspond to an update target spend value of the plurality of update spend values that is associated with a sub-period of time that (directly) proceeds and/or neighbors the exemplary sub-period of time associated with the exemplary update target spend value.

Alternatively and/or additionally, if the exemplary update target spend value is associated with an initial sub-period of time of the period of time (e.g., there is no sub-period of time within the period of time that precedes the initial sub-period of time), the smoothed update target spend value may be equal to:

(smoothingFactor×nextNeighborValue)+((1−smoothingFactor)×exemplary update target spend value).

In some examples, nextNeighborValue may correspond to an update target spend value of the plurality of update spend values that is associated with a sub-period of time that (directly) proceeds and/or neighbors the initial sub-period of time associated with the exemplary update target spend value.

Alternatively and/or additionally, if the exemplary update target spend value is associated with a last sub-period of time of the period of time (e.g., there is no sub-period of time within the period of time that proceeds the initial sub-period of time), the smoothed update target spend value may be equal to:

(smoothingFactor×previousNeighborValue)+((1−smoothingFactor)×exemplary update target spend value).

In some examples, previousNeighborValue may correspond to an update target spend value of the plurality of update spend values that is associated with a sub-period of time that (directly) precedes and/or neighbors the last sub-period of time associated with the exemplary update target spend value.

In some examples, the plurality of update target spend values may be modified such that each update target spend value of the plurality of update target spend values is a smoothed update target spend value. Alternatively and/or additionally, the plurality of update target spend values may be normalized such that a sum of the plurality of update target spend values is (approximately) equal to 1 and/or 24 (and/or a different value, such as a number of sub-periods of time of the plurality of sub-periods of time within the period of time).

FIG. 5E illustrates a second target cumulative spend chart 534 illustrating an example of a second target cumulative spend curve. The vertical axis of FIG. 5E may be indicative of a proportion of the budget that is to be spent and/or the horizontal axis of FIG. 5E may be indicative of sub-periods of time. In some examples, the second target cumulative spend chart 534 may be associated with the updated target spend data structure. For example, the second target cumulative spend curve may be associated with target spending of the budget throughout the second instance of the period of time. Alternatively and/or additionally, an attempt may be made to perform spending of the budget throughout the second instance of the period of time in association with the second target cumulative spend curve.

It may be appreciated that the second target cumulative spend curve is different than the target cumulative spend curve (illustrated in FIG. 5B) in that spending of the budget may not attempted to be performed uniformly and/or linearly (during the second instance of the period of time). For example, by attempting to spend the budget throughout the second instance of the period of time in accordance with the updated target spend data structure and/or the second target cumulative spend curve, rates of spending throughout the sub-periods of time 8-15 may be higher than rates of spending throughout the sub-periods of time 1-7 and/or the sub-periods of time 16-24.

By attempting to spend less (of the budget) during the sub-periods of time 1-7 and/or the sub-periods of time 16-24 and/or by attempting to spend more (of the budget) during the sub-periods of time 8-15, the first content item may be presented more instances, more clicks and/or interactions associated with the first content item may be received and/or more conversions may be achieved as compared with spending uniformly and/or linearly throughout the period of time.

Alternatively and/or additionally, by attempting to spend less (of the budget) during the sub-periods of time 1-7 and/or the sub-periods of time 16-24 and/or by attempting to spend more (of the budget) during the sub-periods of time 8-15, a cost per click associated with the first content item may be less as compared with spending uniformly and/or linearly throughout the period of 24 hours.

Alternatively and/or additionally, by attempting to spend less (of the budget) during the sub-periods of time 1-7 and/or the sub-periods of time 16-24 and/or by attempting to spend more (of the budget) during the sub-periods of time 8-15, a cost per conversion associated with the first content item and/or the first entity may be less as compared with spending uniformly and/or linearly throughout the period of 24 hours.

Alternatively and/or additionally, by attempting to spend less (of the budget) during the sub-periods of time 1-7 and/or the sub-periods of time 16-24 and/or by attempting to spend more (of the budget) during the sub-periods of time 8-15, a return on investment (ROI) associated with the first entity may be more as compared with spending uniformly and/or linearly throughout the period of 24 hours.

In some examples, during the second instance of the period of time (e.g., the second instance of the period of 24 hours), a second plurality of bid values may be generated. Alternatively and/or additionally, the second plurality of bid values may be generated based upon the updated target spend data structure and/or the plurality of update target spend values. For example, for each sub-period of time of the plurality of sub-periods of time, a set of bid values may be generated based upon a corresponding target spend value of the plurality of update target spend values and/or based upon historical spending (e.g., actual spending performed during one or more historical sub-periods of time and/or during a current sub-period of time).

For example, a third set of bid values (of the second plurality of bid values) may be generated at the second instance of the first sub-period of time based upon the first update target spend value and/or based upon historical spending (e.g., actual spending performed during one or more historical sub-periods of time and/or during the second instance of the first sub-period of time). For example, at 416, a third bid value for presenting the first content item at the second instance of the first sub-period of time may be generated. For example, the third bid value may be generated based upon the first update target spend value (of the plurality of update target spend values) associated with the second instance of the first sub-period of time and/or based upon third historical spending (e.g., actual spending performed during one or more historical sub-periods of time and/or during the second instance of the first sub-period of time). In some examples, the third historical spending may correspond to spending of the budget that occurred during one or more sub-periods of time prior to the second instance of the first sub-period of time and/or spending of the budget that occurred during the second instance of the first sub-period of time prior to generating the third bid value.

Alternatively and/or additionally, the third bid value may be generated based upon the first content item bid value and/or a third budget factor value. For example, the third budget factor value may be generated based upon the first update target spend value associated with the second instance of the first sub-period of time and/or based upon historical spending (e.g., the third historical spending). Alternatively and/or additionally, one or more operations (e.g., mathematical operations) may be performed to combine the third budget factor value with the first content item bid value to generate the third bid value. In some examples, the third budget factor value may be a multiplicative factor. For example, the first content item bid value may be multiplied by the third budget factor value to generate the third bid value.

In some examples, a third set of budget factor values may be generated based upon the first update target spend value associated with the second instance of the first sub-period of time and/or based upon historical spending (e.g., actual spending performed during one or more historical sub-periods of time and/or during the second instance of the first sub-period of time). Alternatively and/or additionally, each bid value of the first set of bid values may be generated based upon the first content item bid value and/or a budget factor value of the first set of budget factor values.

Alternatively and/or additionally, a fourth set of bid values (of the second plurality of bid values) may be generated at the second instance of the second sub-period of time based upon the second update target spend value and/or based upon historical spending (e.g., actual spending performed during one or more historical sub-periods of time and/or during the second instance of the second sub-period of time). At 418, a fourth bid value for presenting the first content item at the first instance of the second sub-period of time may be generated. For example, the fourth bid value may be generated based upon the second update target spend value (of the plurality of update target spend values) associated with the second instance of the second sub-period of time and/or based upon fourth historical spending (e.g., actual spending performed during one or more historical sub-periods of time and/or during the second instance of the second sub-period of time). In some examples, the fourth historical spending may correspond to spending of the budget that occurred during one or more sub-periods of time prior to the second instance of the second sub-period of time and/or spending of the budget that occurred during the second instance of the second sub-period of time prior to generating the fourth bid value.

Alternatively and/or additionally, the fourth bid value may be generated based upon the first content item bid value and/or a fourth budget factor value. For example, the fourth budget factor value may be generated based upon the second update target spend value and/or based upon historical spending (e.g., the fourth historical spending). Alternatively and/or additionally, one or more operations (e.g., mathematical operations) may be performed to combine the fourth budget factor value with the first content item bid value to generate the fourth bid value. In some examples, the fourth budget factor value may be a multiplicative factor. For example, the first content item bid value may be multiplied by the fourth budget factor value to generate the fourth bid value.

In some examples, a fourth set of budget factor values may be generated based upon the second update target spend value associated with the second instance of the second sub-period of time and/or based upon historical spending (e.g., actual spending performed during one or more historical sub-periods of time and/or during the second instance of the second sub-period of time). Alternatively and/or additionally, each bid value of the fourth set of bid values may be generated based upon the first content item bid value and/or a budget factor value of the fourth set of budget factor values. In some examples, the fourth set of bid values may be submitted into the auction module associated with the content system.

FIG. 5F illustrates a banner 554 being presented via an exemplary client device 550. For example, the first content item may comprise the banner 554. In some examples, a request for content may be received from the exemplary client device 550 during the second instance of the period of time. For example, the request for content may be received in association with a request to access a webpage 552. In some examples, an exemplary bid value associated with the first content item may be generated and/or submitted into the auction module (responsive to receiving the request for content from the exemplary client device 550). For example, the first content item may be selected, from a plurality of participating content items, for presentation via the exemplary client device 550. The first content item may be selected for presentation via the exemplary client device 550 responsive to a determination that the exemplary bid value is a highest bid value of bid values associated with the plurality of participating content items. Alternatively and/or additionally, the first content item may be selected for presentation via the exemplary client device 550 responsive to a determination that an exemplary predicted probability of a user associated with the exemplary client device 550 positively engaging with the first content item is a highest predicted probability of predicted probabilities associated with the plurality of participating content items.

Alternatively and/or additionally, for each content item of the plurality of participating content items, a predicted probability associated with the content item may be combined wit (e.g., multiplied by) a bid value associated with the content item to generate a weighted bid value. For example, an exemplary weighted bid value associated with the first content item may be generated by performing one or more mathematical operations using the exemplary bid value and the exemplary predicted probability (e.g., the exemplary weighted bid value may be equal to a product of the exemplary bid value and the exemplary predicted probability). In some examples, the first content item may be selected for presentation via the exemplary client device 550 responsive to a determination that the exemplary weighted bid value is a highest weighted bid value of weighted bid values associated with the plurality of participating content items.

In some examples, a second plurality of budget factor values may be generated throughout the second instance of the period of time. For example, the second plurality of budget factor values may comprise the third set of budget factor values (corresponding to the second instance of the first sub-period of time) and/or the fourth set of budget factor values (corresponding to the second instance of the second sub-period of time).

In some examples, a standard deviation, a variance, a difference and/or a different statistic associated with the second plurality of bid values may be less than a standard deviation, a variance and/or a difference among the first plurality of bid values. Alternatively and/or additionally, a standard deviation, a variance, a difference and/or a different statistic associated with the second plurality of budget factor values may be less than a standard deviation, a variance and/or a difference among the first plurality of budget factor values.

In some examples, bid values associated with the first content item may be generated and/or submitted into the auction module for presentation via third party serving areas merely if budget factor values associated with the bid values are greater than a threshold budget factor value. Alternatively and/or additionally, third party entities other than the content entity may receive compensation and/or a traffic acquisition cost (TAC) (e.g., commission) in exchange for the content system presenting the first content item (and/or other content items) using the third party serving areas.

In some examples, by generating bid values in accordance with the updated target spend data structure and/or the second target cumulative spend curve (and/or by attempting to spend the budget throughout the second instance of the period of time in accordance with the updated target spend data structure and/or the second target cumulative spend curve), a number of instances that the first content item is presented via the third party serving areas may be decreased as compared to attempting to spend the budget uniformly and/or linearly. Thus, an amount of compensation paid to the third party entities (and/or a TAC) may be reduced.

For example, by having a decreased standard deviation, variance and/or difference among the second plurality of budget factor values and/or the second plurality of bid values, fewer budget factor values associated with the second plurality of budget factor values may meet the threshold budget factor value (and/or fewer bid values associated with the second plurality of bid values may meet a threshold bid value associated presenting the first content item via third party serving areas) and thus, the first content item is presented via third party serving areas fewer instances. For example, by generating bid values in accordance with the updated target spend data structure and/or the second target cumulative spend curve (and/or by attempting to spend the budget throughout the second instance of the period of time in accordance with the updated target spend data structure and/or the second target cumulative spend curve), fewer budget factor values associated with the second plurality of budget factor values may meet the threshold budget factor (and/or fewer bid values associated with the second plurality of bid values may meet the threshold bid value).

In some examples, one or more first third party entities may be associated with a first level of compensation. Alternatively and/or additionally, one or more second third party entities may be associated with a second level of compensation. For example, the first level of compensation may correspond to a (TAC) range of 0.7 to 0.9 (e.g., 70% to 90% compensation rate) and/or the second level of compensation may correspond to a (TAC) range of 0.5 to 0.69 (e.g., 50% to 69% compensation rate). For example, if the first content item is presented using a third party serving area associated with a third party entity of the one or more first third party entities, between 70% and 90% of income received for presenting the first content item via the third party serving area may be paid to the third party entity. Alternatively and/or additionally, if the first content item is presented using a third party serving area associated with a third party entity of the one or more second third party entities, between 50% and 69% of income received for presenting the first content item via the third party serving area may be paid to the third party entity.

Accordingly, in cases where a budget factor value is greater than the threshold budget factor, it may be beneficial to present content items using third party serving areas associated with the one or more second third party entities (associated with the second level of compensation) rather than presenting content items using third party serving areas associated with the one or more first third party entities (associated with the first level of compensation). For example, bid values associated with the first content item may be generated and/or submitted into the auction module for presentation via third party serving areas associated with the one or more first third party entities merely if budget factor values associated with the bid values are greater than a second threshold budget factor value. The second threshold budget factor value may be greater than the threshold budget factor value.

Alternatively and/or additionally, by generating bid values in accordance with the updated target spend data structure and/or the second target cumulative spend curve (and/or by attempting to spend the budget throughout the second instance of the period of time in accordance with the updated target spend data structure and/or the second target cumulative spend curve), a number of instances that the first content item is presented via the first party serving areas may be increased as compared to attempting to spend the budget uniformly and/or linearly. Thus, an amount of revenue (from presenting the first content item and/or other content items via the first party serving areas) may be increased.

Alternatively and/or additionally, the updating process may be performed (and/or generating the updated target spend data structure may be performed) such that budget factor values of the second plurality of budget factor values are minimized (such that fewer budget factor values associated with the second plurality of budget factor values may meet the threshold budget factor value).

It may be appreciated that the target spend data structure and/or the plurality of target spend values may be associated with a target spend pattern than is not associated with uniform and/or linear spending throughout the first instance of the first period of time. For example, the first portion of the plurality of target spend values (corresponding to active sub-periods of time within the first instance of the period of time) may not be set to a single value (e.g., the first portion of the plurality of target spend values corresponding to active sub-periods of time within the first instance of the period of time may be different than each other).

It may be appreciated that if the first content item and/or the budget associated with the first content item are received from the first client device during the first instance of the first period of time (e.g., after one or more sub-periods of time of the first instance of the period of time have already passed) (and/or if the target spend data structure and/or the plurality of target spend values are generated such that the (entire) budget is attempted to be spent during remaining active sub-periods of time of the first instance of the period of time), a second target spend data structure and/or a second plurality of target spend values may be generated for the second instance of the period of time. For example, the second target spend data structure and/or the second plurality of target spend values may be associated with spending (the budget) uniformly and/or linearly throughout the second instance of the period of time. Alternatively and/or additionally, the updated target spend data structure and/or the plurality of update target spend values may be generated for a third instance of the period of time (rather than for the second instance of the period of time) (e.g., it may be attempted to spend the budget non-uniformly and/or non-linearly throughout the third instance of the period of time).

It may be appreciated that a plurality of updating processes may be performed. For example, each updating process may be performed based upon and/or responsive to a budget reset (e.g., a budget reset may occur when the (entire) budget is spent during an instance of the period of time and/or when an instance of the period of time is completed). For example, each updating process of the plurality of updating processes may comprise generating a (updated) target spend data structure for an instance of the period of time based upon a plurality of budget factor values generated for (and/or during) a previous instance of the period of time. For example, after performing the plurality of updating processes, an exemplary updated target spend data structure may be generated. For example, the exemplary updated target spend data structure may be associated with an exemplary target cumulative spend curve illustrated in a third target cumulative spend chart 558 in FIG. 5G. The vertical axis of FIG. 5G may be indicative of a proportion of the budget that is to be spent and/or the horizontal axis of FIG. 5G may be indicative of sub-periods of time.

Implementation of at least some of the disclosed subject matter may lead to benefits including, but not limited to, an increase in instances that the first content item is presented via client devices, an increase in received clicks and/or interactions with the first content item, an increase in conversions associated with the first entity, etc. as a result of attempting to spend less (of the budget) during sub-periods of time associated with higher effort (e.g., sub-periods of time associated with a lower amount of internet traffic and/or a lower supply of client devices requesting content from the content system (e.g., such as the sub-periods of time 1-7 and/or the sub-periods of time 16-24)), as a result of attempting to spend more (of the budget) during sub-periods of time associated with lower effort (e.g., sub-periods of time associated with a higher amount of internet traffic and/or a higher supply of client devices requesting content from the content system (e.g., such as the sub-periods of time 8-15)), etc.

Alternatively and/or additionally, implementation of at least some of the disclosed subject matter may lead to benefits including a reduction in compensation paid to entities different than the content entity (and/or a reduction in TAC), an increase in revenue for the content entity, etc. as a result of increasing a number of instances that the first content item is presented via the first party serving areas and/or decreasing a number of instances that the first content item is presented via the third party serving areas.

In some examples, at least some of the disclosed subject matter may be implemented on a client device, and in some examples, at least some of the disclosed subject matter may be implemented on a server (e.g., hosting a service accessible via a network, such as the Internet).

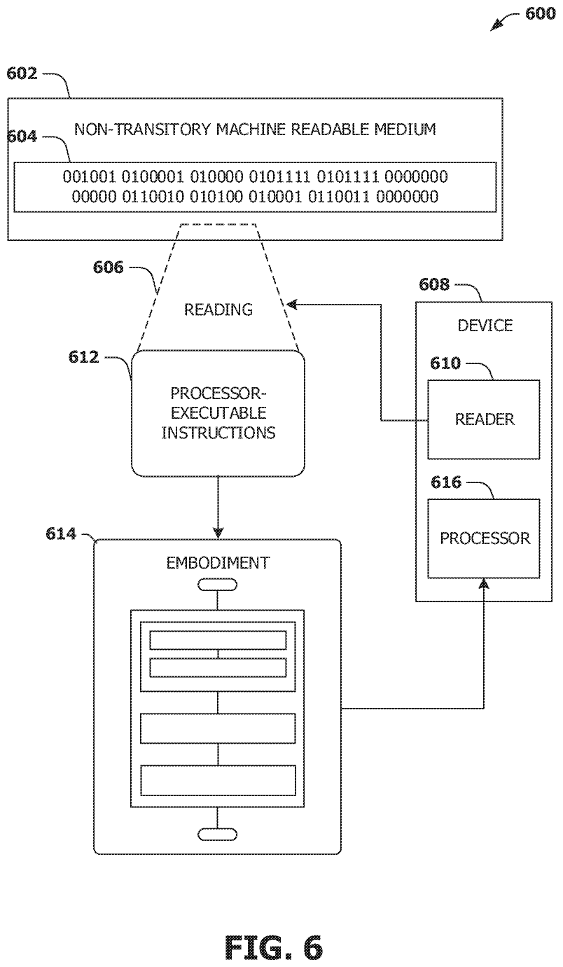

FIG. 6 is an illustration of a scenario 600 involving an example non-transitory machine readable medium 602. The non-transitory machine readable medium 602 may comprise processor-executable instructions 612 that when executed by a processor 616 cause performance (e.g., by the processor 616) of at least some of the provisions herein (e.g., embodiment 614). The non-transitory machine readable medium 602 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disc (CD), digital versatile disc (DVD), or floppy disk). The example non-transitory machine readable medium 602 stores computer-readable data 604 that, when subjected to reading 606 by a reader 610 of a device 608 (e.g., a read head of a hard disk drive, or a read operation invoked on a solid-state storage device), express the processor-executable instructions 612. In some embodiments, the processor-executable instructions 612, when executed, cause performance of operations, such as at least some of the example method 400 of FIGS. 4A-4B, for example. In some embodiments, the processor-executable instructions 612 are configured to cause implementation of a system, such as at least some of the example system 501 of FIGS. 5A-5G, for example.

3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer and/or machine readable media, which if executed will cause the operations to be performed. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
receiving, from a client device associated with an entity, a first content item and a budget associated with the first content item;
generating a target spend data structure associated with the first content item, wherein:
the target spend data structure comprises a plurality of target spend values;
each target spend value of the plurality of target spend values is associated with spending performed during a sub-period of time of a plurality of sub-periods of time within a first instance of a period of time;
the spending is performed based upon the budget; and
the spending is performed for presenting the first content item via client devices;
generating, based upon a first target spend value of the plurality of target spend values, a first bid value for presenting the first content item at a first instance of a first sub-period of time of the plurality of sub-periods of time, wherein the first target spend value is associated with the first instance of the first sub-period of time;
generating, based upon a second target spend value of the plurality of target spend values, a second bid value for presenting the first content item at a first instance of a second sub-period of time of the plurality of sub-periods of time, wherein the second target spend value is associated with the first instance of the second sub-period of time;
generating a first update target spend value, associated with a second instance of the first sub-period of time, based upon a first budget factor calculation corresponding to the first instance of the first sub-period of time and a second budget factor calculation corresponding to the first instance of the period of time;
generating a second update target spend value, associated with a second instance of the second sub-period of time, based upon a third budget factor calculation corresponding to the first instance of the second sub-period of time and the second budget factor calculation;
generating an updated target spend data structure, associated with the first content item, comprising the first update target spend value associated with the second instance of the first sub-period of time and the second update target spend value associated with the second instance of the second sub-period of time;
generating, based upon the first update target spend value in the updated target spend data structure, a third bid value for presenting the first content item at the second instance of the first sub-period of time; and
generating, based upon the second update target spend value in the updated target spend data structure, a fourth bid value for presenting the first content item at the second instance of the second sub-period of time.

2. The method of claim 1, wherein:
the generating the first update target spend value comprises combining the first budget factor calculation with the second budget factor calculation; and
the generating the second update target spend value comprises combining the third budget factor calculation with the second budget factor calculation.

3. The method of claim 1, wherein:
the first budget factor calculation is associated with a combination of a first plurality of budget factor values associated with the first instance of the first sub-period of time;
the third budget factor calculation is associated with a combination of a second plurality of budget factor values associated with the first instance of the second sub-period of time; and
the second budget factor calculation is associated with a combination of a third plurality of budget factor values associated with the first instance of the period of time, wherein the third plurality of budget factor values comprises the first plurality of budget factor values and the second plurality of budget factor values.

4. The method of claim 1, wherein:
the first budget factor calculation is associated with an average of a first plurality of budget factor values associated with the first instance of the first sub-period of time;
the third budget factor calculation is associated with an average of a second plurality of budget factor values associated with the first instance of the second sub-period of time; and
the second budget factor calculation is associated with an average of a third plurality of budget factor values associated with the first instance of the period of time, wherein the third plurality of budget factor values comprises the first plurality of budget factor values and the second plurality of budget factor values.

5. The method of claim 1, comprising:
generating, for the first instance of the period of time, a first plurality of bid values for presenting the first content item at the first instance of the period of time, wherein the first plurality of bid values comprises the first bid value and the second bid value; and
generating, for a second instance of the period of time, a second plurality of bid values for presenting the first content item at the second instance of the period of time, wherein:
the second plurality of bid values comprises the third bid value and the fourth bid value; and
the second instance of the first sub-period of time and the second instance of the second sub-period of time are within the second instance of the period of time.

6. The method of claim 5, wherein a first variance associated with the first plurality of bid values is greater than a second variance associated with the second plurality of bid values.

7. The method of claim 1, wherein:
the period of time is associated with a period of 24 hours;
each sub-period of time of the plurality of sub-periods of time is associated with an hour of the period of 24 hours;
the first instance of the period of time is associated with a first instance of the period of 24 hours;
a second instance of the period of time is associated with a second instance of the period of 24 hours;
the first instance of the period of 24 hours precedes the second instance of the period of 24 hours; and
the second instance of the first sub-period of time and the second instance of the second sub-period of time are within the second instance of the period of time.

8. The method of claim 7, wherein:
the first instance of the first sub-period of time is associated with a first hour of the first instance of the period of 24 hours;
the second instance of the first sub-period of time is associated with the first hour of the second instance of the period of 24 hours;
the first instance of the second sub-period of time is associated with a second hour of the first instance of the period of 24 hours; and
the second instance of the second sub-period of time is associated with the second hour of the second instance of the period of 24 hours.

9. The method of claim 1, wherein:
the first update target spend value is associated with a combination of the first budget factor calculation, the second budget factor calculation and a first smoothing factor; and
the second update target spend value is associated with a combination of the third budget factor calculation, the second budget factor calculation and a second smoothing factor.

10. The method of claim 1, comprising:
submitting the first bid value into an auction module during the first instance of the first sub-period of time;
submitting the second bid value into the auction module during the first instance of the second sub-period of time;
submitting the third bid value into the auction module during the second instance of the first sub-period of time; and
submitting the fourth bid value into the auction module during the second instance of the second sub-period of time.

11. A computing device comprising:
a processor; and
memory comprising processor-executable instructions that when executed by the processor cause performance of operations, the operations comprising:
identifying a first content item, wherein the first content item is associated with an entity and a budget;
identifying a target spend data structure associated with the first content item, wherein:
the target spend data structure comprises a plurality of target spend values;
each target spend value of the plurality of target spend values is associated with spending performed during a sub-period of time of a plurality of sub-periods of time within a first instance of a period of time;
the spending is performed based upon the budget; and
the spending is performed for presenting the first content item via client devices;
generating a first update target spend value, associated with a second instance of a first sub-period of time of the plurality of sub-periods of time, based upon a first budget factor calculation corresponding to a first instance of the first sub-period of time and a second budget factor calculation corresponding to the first instance of the period of time, wherein the first instance of the first sub-period of time is within the first instance of the period of time and the second instance of the first sub-period of time is within a second instance of the period of time;
generating a second update target spend value, associated with a second instance of a second sub-period of time of the plurality of sub-periods of time, based upon a third budget factor calculation corresponding to a first instance of the second sub-period of time and the second budget factor calculation, wherein the first instance of the second sub-period of time is within the first instance of the period of time and the second instance of the second sub-period of time is within the second instance of the period of time;
generating an updated target spend data structure, associated with the first content item, comprising the first update target spend value associated with the second instance of the first sub-period of time and the second update target spend value associated with the second instance of the second sub-period of time;
generating, based upon the first update target spend value in the updated target spend data structure, a first bid value for presenting the first content item at the second instance of the first sub-period of time; and
generating, based upon the second update target spend value in the updated target spend data structure, a second bid value for presenting the first content item at the second instance of the second sub-period of time.

12. The computing device of claim 11, wherein:
the generating the first update target spend value comprises combining the first budget factor calculation with the second budget factor calculation; and
the generating the second update target spend value comprises combining the third budget factor calculation with the second budget factor calculation.

13. The computing device of claim 11, wherein:
the first budget factor calculation is associated with a combination of a first plurality of budget factor values associated with the first instance of the first sub-period of time;
the third budget factor calculation is associated with a combination of a second plurality of budget factor values associated with the first instance of the second sub-period of time; and
the second budget factor calculation is associated with a combination of a third plurality of budget factor values associated with the first instance of the period of time, wherein the third plurality of budget factor values comprises the first plurality of budget factor values and the second plurality of budget factor values.

14. The computing device of claim 11, wherein:
the first budget factor calculation is associated with an average of a first plurality of budget factor values associated with the first instance of the first sub-period of time;
the third budget factor calculation is associated with an average of a second plurality of budget factor values associated with the first instance of the second sub-period of time; and
the second budget factor calculation is associated with an average of a third plurality of budget factor values associated with the first instance of the period of time, wherein the third plurality of budget factor values comprises the first plurality of budget factor values and the second plurality of budget factor values.

15. The computing device of claim 11, the operations comprising:
generating, for the first instance of the period of time, a first plurality of bid values for presenting the first content item at the first instance of the period of time; and
generating, for the second instance of the period of time, a second plurality of bid values for presenting the first content item at the second instance of the period of time, wherein the second plurality of bid values comprises the first bid value and the second bid value.

16. The computing device of claim 15, wherein a first variance associated with the first plurality of bid values is greater than a second variance associated with the second plurality of bid values.

17. A non-transitory machine readable medium having stored thereon processor-executable instructions that when executed cause performance of operations, the operations comprising:
identifying a first content item, wherein the first content item is associated with an entity and a budget;
identifying a target spend data structure associated with the first content item, wherein:
the target spend data structure comprises a plurality of target spend values;
each target spend value of the plurality of target spend values is associated with spending performed during a sub-period of time of a plurality of sub-periods of time within a first instance of a period of time;
the spending is performed based upon the budget; and
the spending is performed for presenting the first content item via client devices;
generating a first update target spend value, associated with a second instance of a first sub-period of time of the plurality of sub-periods of time, based upon a first budget factor calculation corresponding to a first instance of the first sub-period of time and a second budget factor calculation corresponding to the first instance of the period of time, wherein the first instance of the first sub-period of time is within the first instance of the period of time and the second instance of the first sub-period of time is within a second instance of the period of time;
generating a second update target spend value, associated with a second instance of a second sub-period of time of the plurality of sub-periods of time, based upon a third budget factor calculation corresponding to a first instance of the second sub-period of time and the second budget factor calculation, wherein the first instance of the second sub-period of time is within the first instance of the period of time and the second instance of the second sub-period of time is within the second instance of the period of time;
generating an updated target spend data structure, associated with the first content item, comprising the first update target spend value associated with the second instance of the first sub-period of time and the second update target spend value associated with the second instance of the second sub-period of time;
generating, based upon the first update target spend value in the updated target spend data structure, a first bid value for presenting the first content item at the second instance of the first sub-period of time; and
generating, based upon the second update target spend value in the updated target spend data structure, a second bid value for presenting the first content item at the second instance of the second sub-period of time.

18. The non-transitory machine readable medium of claim 17, wherein:
the generating the first update target spend value comprises combining the first budget factor calculation with the second budget factor calculation; and
the generating the second update target spend value comprises combining the third budget factor calculation with the second budget factor calculation.

19. The non-transitory machine readable medium of claim 17, wherein:
the first budget factor calculation is associated with a combination of a first plurality of budget factor values associated with the first instance of the first sub-period of time;
the third budget factor calculation is associated with a combination of a second plurality of budget factor values associated with the first instance of the second sub-period of time; and
the second budget factor calculation is associated with a combination of a third plurality of budget factor values associated with the first instance of the period of time, wherein the third plurality of budget factor values comprises the first plurality of budget factor values and the second plurality of budget factor values.

20. The non-transitory machine readable medium of claim 17, wherein:
the first budget factor calculation is associated with an average of a first plurality of budget factor values associated with the first instance of the first sub-period of time;
the third budget factor calculation is associated with an average of a second plurality of budget factor values associated with the first instance of the second sub-period of time; and
the second budget factor calculation is associated with an average of a third plurality of budget factor values associated with the first instance of the period of time, wherein the third plurality of budget factor values comprises the first plurality of budget factor values and the second plurality of budget factor values.
